(19) United States
(12) Patent Application Publication
(10) Pub. No.: US 2004/0130887 A1
(43) Pub. Date: Jul. 8, 2004

(54) Shoe light device with multiple color variations

(76) Inventor: Meng Pi Wei, Yongho City (TW)

Correspondence Address: BROWDY AND NEIMARK, P.L.L.C., 624 NINTH STREET, NW, SUITE 300, WASHINGTON, DC, 20001-5303, US

(21) Appl. No.: 10/336,715

(22) Filed: Jan. 6, 2003

(51) Int. Cl. F21V 21/08

(52) U.S. Cl. 362/103; 362/276; 362/802

(57) ABSTRACT

A shoe light device with multiple color variations has at least a color-mixing LED, a power source, a vibration switch and a control IC. The color-mixing LED has several light-emitting chips of different colors, and is used to generate light of various colors. The power source provides electricity for the color-mixing LED. The vibration switch generates a trigger signal to the control IC when shocked. The control IC generates a drive signal to drive the color-mixing LED to flash a single-color light at least once after receiving the trigger signal. The color-mixing LED flashes a different single-color light each time according to a light color table determining the color variation order and frequency after receiving the drive signal. When a user wearing a shoe with the shoe light device installed therein walks, variations of different single-color lights can be displayed along with his steps.

### FIELD OF THE INVENTION

The present invention relates to a shoe light device with multiple color variations and, more particularly, to a shoe light device capable of emitting multiple color variations through a color-mixing light-emitting diode.

### BACKGROUND OF THE INVENTION

Curiosity for pursuing new things always urges people to change the present situation and to search for unusual sensual stimulation. For instance, shoes worn by people as means of transportation in every day no longer only provide protection for the feet. Shoe bodies constantly undergo redesign in the pursuit of new sensual stimulation. In addition to making static variations to the shape of the shoe or the color and pattern of the surface of the shoe, people also add lighting and flashing devices to the shoes. Because lighting and flashing devices display dynamic visual effects, they can more easily attract other people's eyes. In particular, lighting variations made when people walk at night have the dual effects of a warning device and aesthetic ornament.

A shoe light device shown in FIG. 1 is installed in a shoe (not shown). In the shoe light device, a vibration switch 1a is connected with an input terminal of a control unit 2a, and several monochrome light-emitting diodes (LEDs) 3a (installed at visible portions of the shoe) are connected with output terminals of the control unit 2a. Trigger signals from the vibration switch la can be received by the internal circuit of the control unit 2a to let the LEDs show four kinds of reciprocating flashing modes with 1 to 5 seconds between every two flashes. When a user wears a shoe with the shoe light device installed therein, vibration generated when walking causes the vibration switch to generate trigger signals. The internal circuit of the control unit 2a drives the LEDs to flash in a reciprocating way according to the received trigger signals.

For the above conventional shoe light device, the lighting variations in practical use are accomplished only through several monochrome LEDs, hence being monotonous, not diversified and repetitious.

### SUMMARY AND OBJECTS OF THE PRESENT INVENTION

The primary object of the present invention is to provide a shoe light device with multiple color variations, in which a color-mixing LED is utilized to mix lights of different colors to let the shoe light device show various beautiful colors, hence having a dazzling effect.

Another object of the present invention is to provide a shoe light device with multiple color variations, which emits light of a different single color with each step to show variegated and interesting visual effects along with his steps.

To achieve the above objects, the present invention provides a shoe light device with multiple color variations, which comprises at least a color-mixing LED, a power source, a vibration switch and a control IC. The color-mixing LED is composed of several light-emitting chips of different colors, and is used to generate light of several kinds of colors. The power source provides electricity for the color-mixing LED. The vibration switch generates a trigger signal when vibrated. The control IC generates a drive signal to push the color-mixing LED to flash a single color light at least once after receiving the trigger signal. The color-mixing LED flashes a different single color light each time according to a light color table determining the color variation order and frequency after receiving the drive signal.

The various objects and advantages of the present invention will be more readily understood from the following detailed description when read in conjunction with the appended drawings, in which:

### BRIEF DESCRIPTION OF DRAWING

FIG. 1 is a schematic, exploded perspective view of a conventional shoe light device;

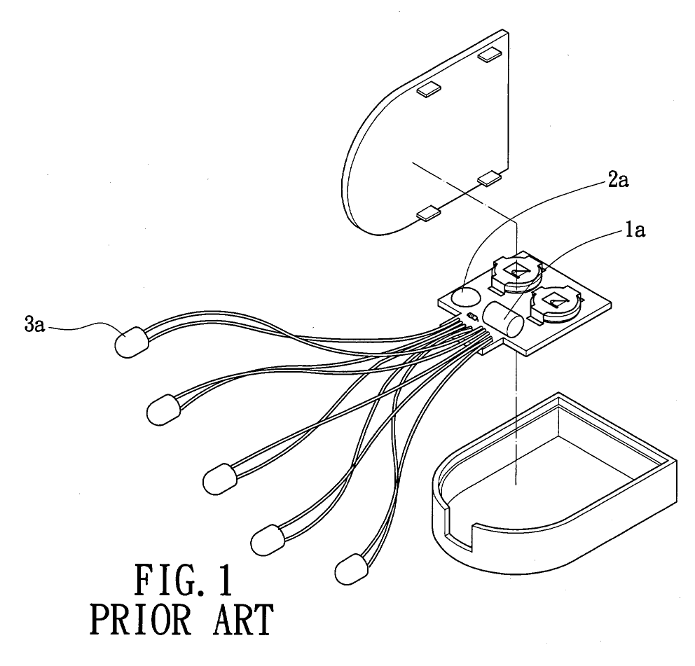

FIG. 2 is a schematic perspective view of the present invention;

FIG. 3 is a schematic circuit pin diagram of a control IC of the present invention;

FIG. 4 is a schematic circuit block diagram of a control IC of the present invention; and

FIG. 5 is a schematic diagram showing installation of the present invention in a shoe.

### DETAILED DESCRIPTION OF PREFERRED EMBODIMENT

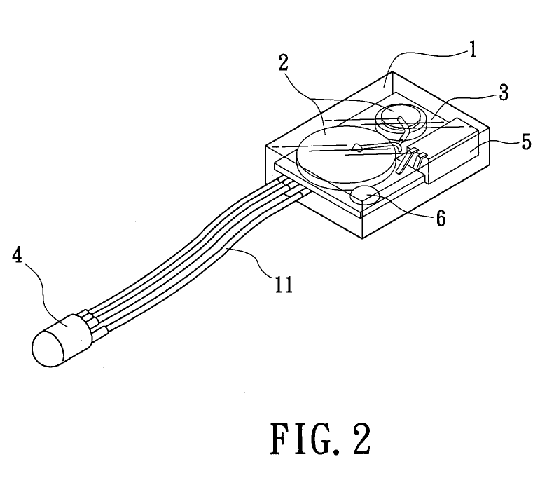

As shown in FIG. 2, the present invention provides a shoe light device with multiple color variations, which comprises a shell body 1, a power source 2, a substrate 3, a conductive wire 11, a color-mixing LED 4, a vibration switch 5 and a control IC 6.

The power source 2 is disposed in the shell body 1, and provides a voltage of 4.5V or 6V. The 4.5V power source is composed of a 3V battery and a 1.5V battery, and the 3V battery is a lithium battery (CR-2032 or CR-2450). The 6V power source is composed of two 3V lithium batteries. The conductive wire 11 is led out from the substrate 3 and pulled out of the shell body 1. The other end of the conductive wire 11 is connected to the color-mixing LED 4 having 3 or 4 pins. The color-mixing LED 4 has three light-emitting chips of the red (R), green (G) and blue (B) colors, and can show lights of different colors of multiple color series by mixing. The vibration switch 5 and the control IC 6 are disposed on the substrate 3. When the shell body 1 is influenced by an external force (e.g., vibration) each time, the vibration switch 5 triggers the control IC 6, which then generates a drive signal to cause the color-mixing LED to flash a single-color light at least once. Moreover, the color-mixing LED flashes a different single-color light each time according to a light color table (e.g., circulation of the blue, red, white, orange and green colors) determining the color variation order and frequency after receiving the drive signal.

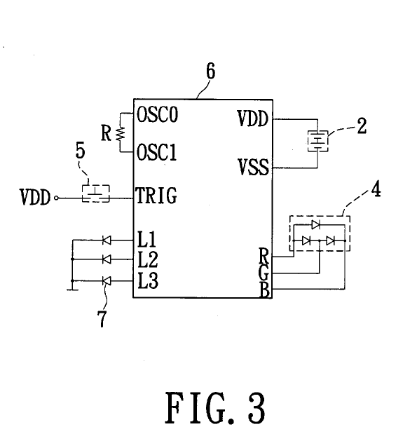

As shown in FIG. 3, the control IC 6 is electrically connected with the power source 2, the color-mixing LED 4, the vibration switch 5 and a vibration resistor R. In order to drive the color-mixing LED 4 to radiate normally a voltage of 4.5V or 6V is used. In order to further increase lighting variations of the shoe light device, in addition to the primary light of the color-mixing LED 4, several secondary lights of LEDs 2 are also electrically connected with the control IC 6.

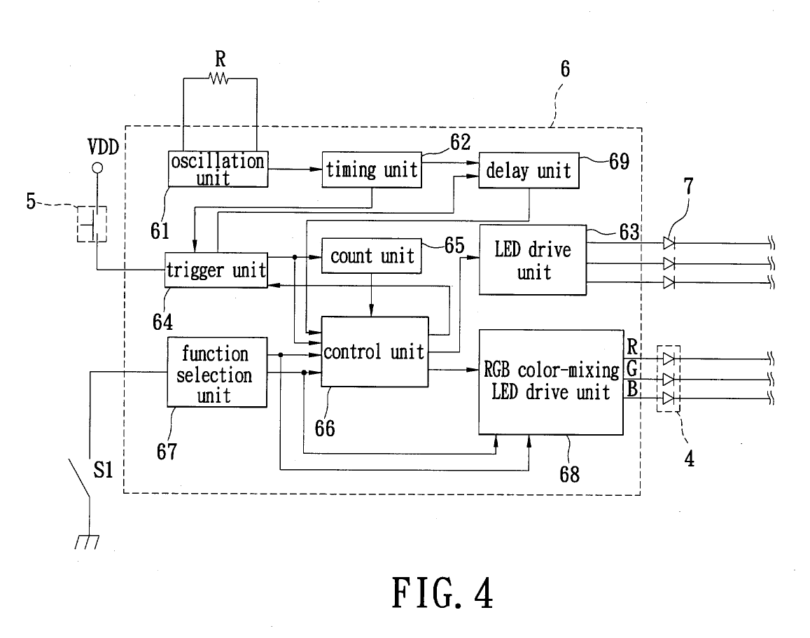

As shown in FIG. 4, the control IC 6 is composed of an oscillation unit 61, a timing unit 62, a delay unit 63, a trigger unit 64, a count unit 65, a control unit 66, a function selection unit 67, a RGB color-mixing LED drive unit 68 and a LED drive unit 69.

The oscillation unit 61 and the timing unit 62 are used to generate a working frequency to the trigger unit 64 and the delay unit 63. The delay unit 63 is used to generate a delay signal to the control unit 66 to control the illumination time of the color-mixing LED 4. The trigger unit 64 is electrically connected with the vibration switch 5. When the vibration switch 5 is vibrated, it generates a trigger signal to the delay unit 63, the count unit 65 and the control unit 66. The count unit 65 generates a reset signal to the control unit 66 after receiving the trigger signal a fixed number of times, hence causing the color-mixing LED 4 to radiate circularly again according to the light color table.

The control unit 66 controls the illumination actions of the color-mixing LED 4. The function selection unit 67 is electrically connected with a switch S1. The light color table can be switched through the switch S1 to control the color-mixing LED 4 to show different illumination modes. The light color table can be divided into a male mode and a female mode. In the male mode, five color variations of the blue; red, white; orange and green are provided to the color-mixing LED 4 to radiate circularly to show different single-color variations. In the female mode, five color variations of the blue, red, white, violet and green are provided to the color-mixing LED 4 to radiate circularly and show different single-color variations. The RGB color-mixing LED drive unit 68 receives the drive signal from the control unit 66 to control the illumination state of the color-mixing LED 4. The LED drive unit 69 receives the drive signal from the control unit 66 to control the illumination state of the LEDs 7.

The trigger unit 64 generates a trigger signal to the control unit 66 when the vibration switch 61 is vibrated. The control unit 66 then sends out a drive signal to the RGB color-mixing LED 68 after a period of delay time according to a delay signal of the delay unit 63. At this time, the color-mixing LED 4 emits a monochromatic light for a period of time. The light emitted by the color-mixing LED 4 each time is based on the light color table for circulatory lighting. If the male mode is specified, the color-mixing LED 4 radiates blue, red, white, orange and green lights in turn. Whether the trigger times kept by the count unit 65 equals the total times of color variation in the light color table is determined. That is, if the count unit 65 counts to 5, it sends out a reset signal to the control unit 66 to let the color-mixing LED 4 to radiate in turn from the blue color in the light color table again.

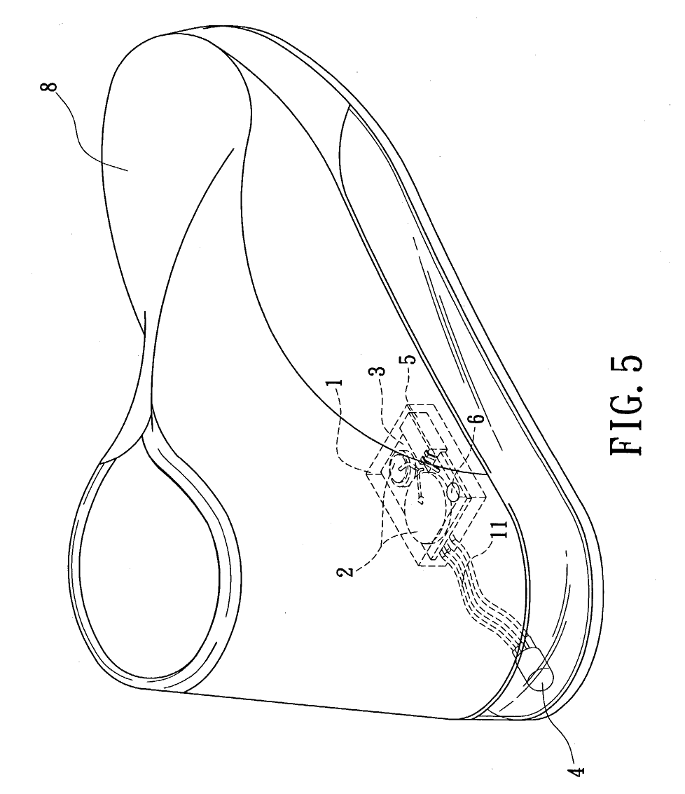

As shown in FIG. 5, the shoe light device in FIG. 2 is installed in a shoe 8, and the color-mixing LED 4 is visibly exposed on the shoe 8. When a man wearing the shoe walks, the color-mixing LED 4 radiates blue, red, white, orange and green colors in turn according to his steps. In other words, when he makes a first step, the color-mixing LED 4 radiates the blue light for a period of time, and when he makes a second step, the color-mixing LED 4 radiates the red light for a period of time, and so on. When he makes the sixth step, the color-mixing LED 4 radiates the blue light for a period of time again. The above ruminant order is repeated continually. Therefore, when a user wearing the shoe 8 walks, light variation of multiple color series can be displayed to enhance the fun of wearing the shoe 8 and to build a more dazzling effect.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A shoe light device with multiple color variations, comprising:
at least a color-mixing LED composed of several light-emitting chips of different colors, said color-mixing LED being used to generate lights of several colors;
a power source for providing electricity for said color-mixing LED;
a vibration switch for generating a trigger signal when vibrated; and
a control IC for generating a drive signal to drive said color-mixing LED to flash a single-color light at least once when receiving said trigger signal, said color-mixing LED flashing a different single-color light each time according to a light color table determining the color variation order and times after receiving said drive signal.

2. The shoe light device with multiple color variations as claimed in claim 1, wherein said color-mixing LED is composed of light-emitting chips of red, green and blue colors.

3. The shoe light device with multiple color variations as claimed in claim 1, wherein said color-mixing LED has 3 or 4 pins.

4. The shoe light device with multiple color variations as claimed in claim 1, wherein said color-mixing LED is disposed upon a visible portion of a shoe.

5. The shoe light device with multiple color variations as claimed in claim 1, wherein said power source is 4.5V, and is composed of a 3V battery and a 1.5V battery.

6. The shoe light device with multiple color variations as claimed in claim 5, wherein said 3V battery is a lithium battery.

7. The shoe light device with multiple color variations as claimed in claim 6, wherein said lithium battery is a CR-2032 or CR-2450 battery.

8. The shoe light device with multiple color variations as claimed in claim 1, wherein said power source is 6V.

9. The shoe light device with multiple color variations as claimed in claim 8, wherein said 6V power source is composed of two 3V lithium batteries.

10. The shoe light device with multiple color variations as claimed in claim 9, wherein said lithium batteries are CR-2032 or CR-2450.

11. The shoe light device with multiple color variations as claimed in claim 1, wherein said control IC comprises:
a trigger unit electrically connected to said vibration switch and used to generate said trigger signal;
a count unit electrically connected to said trigger unit and used to count frequency of said trigger signal for generating a reset signal;
a color-mixing LED drive unit for driving said color-mixing LED to emit light; and
a control unit used to receive said trigger signal and to generate said drive signal to said color-mixing LED drive unit, said control unit also inducing said color-mixing LED to flash different single-color lights circularly again according to said light color table after receiving said reset signal.

12. The shoe light device with multiple color variations as claimed in claim 11, wherein said control IC further comprises a function selection unit, which determines said light color table through a switch.

13. The shoe light device with multiple color variations as claimed in claim 11, wherein said control IC is further electrically connected to several secondary lights of LEDs.

14. The shoe light device with multiple color variations as claimed in claim 11, wherein said control IC further comprises a delay unit for controlling illumination time of said color-mixing LED.

15. The shoe light device with multiple color variations as claimed in claim 11, wherein said count unit generates said reset signal only when the frequency of said trigger signal equals the total times of color variation in said light color table.
